(19) United States
(12) Patent Application Publication
(10) Pub. No.: US 2004/0242397 A1
(43) Pub. Date: Dec. 2, 2004

(54) Optical glass

(75) Inventor: Yoshiyuki Nakayama, Yotsukaido-shi (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HIKARI GLASS CO., LTD.

(21) Appl. No.: 10/849,925

(22) Filed: May 21, 2004

(30) Foreign Application Priority Data
Nov. 25, 2002 (JP) 2002-341401

(51) Int. Cl. C03C 3/068; C03C 3/095; C03C 3/089

(52) U.S. Cl. 501/64; 501/65; 501/78

(57) ABSTRACT

An optical glass that has a refractive index (nd) of 1.56-1.66, an Abbe number (vd) of 52-63, and a transformation temperature of 420° C.-580° C., as provided by compositions including as essential components (a) SiO₂, (b) B₂O₃, (c) BaO, (d) Y₂O₃, (e) Li₂O, and (f) one or more from CaO, MgO, SrO, and ZnO, and optionally one or more components from (g) Na₂O, (h) K₂O, (i) Al₂O₃, and (j) ZrO₂.

### BACKGROUND OF THE INVENTION

This invention relates to an optical glass, and more particularly to an SiO₂—B₂O₃—BaO—Li₂O—Y₂O₃—RO (R=Mg, Ca, Sr, Zn)-based optical glass having improved moldability. Barium crown glasses and dense-crown glasses have been widely mass-manufactured. The molding temperature of these types of glass must be high, due to their high softening temperature of more than 600° C. They are, therefore, generally unsuitable for manufacturing optical elements, which are usually press-molded without grinding or polishing after being molded.

Glass compositions having low softening temperatures are described in patent documents. Japanese Unexamined Published Patent Application No. H04-292435 discloses a glass composed of an alkaline metal oxide and TeO₂. This glass, however, is economically unsatisfactory, due to its use of TeO₂, which is expensive. Japanese Unexamined Published Patent Application No. S60-122747 discloses a SiO₂-B₂O₃—CaO—Li₂O-based glass. However, the glass of this composition has poor chemical durability and is not suitable for press-molding. Japanese Unexamined Published Patent Application No. H06-107425 discloses a Nb₂O₅ glass that includes TiO₂ to improve meltability. This glass is also economically unsatisfactory because the Nb₂O₅ is expensive.

Under these circumstances, there has been a strong need for economical optical-glass compositions that have a refractive index (nd) of 1.56-1.66 and an Abbe number (vd) of 52-63, and that can be molded at a lower temperature.

### SUMMARY OF THE INVENTION

The primary object of the present invention is to provide an optical glass that has a low transformation temperature (Tg) while maintaining specific physical properties.

Another object of the present invention is to provide an optical glass that can be press-molded.

Another object of the present invention is to provide an optical glass that has improved stain resistance.

Another object of the present invention is to provide an optical glass that is composed only of inexpensive components.

These objects are achieved by providing an optical glass that includes: (a) SiO₂ in an amount ranging from 38% to 62% by weight (hereinafter “wt %”); (b) B₂O₃ in an amount ranging from 1 wt % to 15 wt %; (c) BaO in an amount ranging from 2 wt % to 9 wt %; (d) Y₂O₃ in an amount ranging from 1 wt % to 10 wt %; (e) Li₂O in an amount ranging from 3 wt % to 12 wt %; and (f) one or more oxides selected from (1) CaO in an amount less than 33 wt %, (2) MgO in an amount less than 16 wt %, (3) SrO in an amount less than 20 wt %, and (4) ZnO in an amount less than 20 wt %, but with the total of said oxide(s) to be in an amount of 10 wt % to 55 wt %.

Optical glass of this invention can further contain one or more of compositions from (g) Na₂O, (h) K₂O, (i) Al₂O₃, and (j) ZrO₂, wherein the sum of (g) Na₂O and (h) K₂O is in an amount less than 17 wt %, (i) Al₂O₃ is in an amount less than 10 wt %, and (j) ZrO₂ is in an amount less than 10 wt %.

It is preferable that optical glass have a refractive index (nd) of 1.56-1.66, an Abbe number (vd) of 52-63, and a transformation temperature of 420° C.-580° C.

### DESCRIPTION OF THE PREFERRED EMBODIMENTS

Optical glass according to the present invention includes specific components as described above. Each of these components has different functions in optical glass. The specific combination of these components can bring about a low transformation temperature, an appropriate refractive index, and an Abbe number (vd) suitable for optical glass, while satisfying other basic requirements. Thus, the ratios of these components are determined based on a subtle balance of the components for each composition. In other words, satisfactory optical glass can be obtained only when all of these components are well-balanced within the above-mentioned ranges.

SiO₂, an oxide of a basic glass-structure, is incorporated so as to impart the desired refractive index. The level of SiO₂ in optical glass will be held at 38 wt % to 62 wt %, preferably at 41 wt % to 62 wt %. A content of less than 38 wt % might lower the chemical durability, and a content in excess of 62 wt % can excessively reduce the meltability and raise the transformation temperature.

B₂O₃ is also a glass-forming oxide, and in optical glass it will be held at 1 wt % to 15 wt %, preferably at 3 wt % to 11 wt %. A content of less than 1 wt % can excessively reduce the meltability of the glass and increase its devitrification tendency, and a content in excess of 15 wt % can lower the chemical durability of the glass.

BaO increases the refractive index of the glass and represses the devitrification that occurs in the glass. BaO will be held at 2 wt % to 9 wt %, preferably 5 wt % to 9 wt % in optical glass. A content of less than 2 wt % might be too little for the BaO to be effective, and a content in excess of 9 wt % might lower the chemical durability of the glass.

Y₂O₃ increases the refractive index of the glass and improves its chemical durability. The level of Y₂O₃ in optical glass will be held at 1 wt % to 10 wt %. A content of less than 1 wt % might be too little for the Y₂O₃ to be effective, and a content in excess of 10 wt % can excessively reduce the meltability of the glass.

Li₂O is effective for lowering the transformation temperature, and it will be held at 3 wt % to 12 wt %, preferably at 4 wt % to 12 wt % in optical glass. A content of less than 3 wt % might be too little for the Y₂O₃ to be effective, and a content in excess of 10 wt % might excessively reduce the chemical durability of the glass.

CaO, MgO, SrO, and ZnO increase the refractive index of the glass, raise its chemical durability, and improve its meltability, although each of those do not work exactly the same. For optical glass, one or some combination of these is selected within the following ranges: CaO, not more than 33 wt %; MgO, not more than 16 wt %; SrO, not more than 20 wt %; ZnO, not more than 20 wt %; and the sum of them should be in the range of 10 wt % to 55 wt %, preferably at 10 wt % to 48 wt %. If the above limits are exceeded, the glass can be devitrified and the transformation temperature might become too high.

In addition to the above-mentioned components, the optical glass of this invention can contain one or more of compositions from (g) Na₂O, (h) K₂O, (i) Al₂O₃, and (j) ZrO₂.

Both Na₂O and K₂O lower the transformation temperature, and, when combined with Li₂O, improve the meltability of the glass, as stated above. The total of Na₂O and K₂O will be not more than 17 wt %. If the amount is more than 17 wt %, the chemical durability of the glass might be reduced excessively.

Al₂O₃ improves the resistance against devitrification and enhances the chemical durability of the glass, and is used in an amount of not more than 10 wt %. If the amount is more than 10 wt %, the meltability of the glass might be reduced excessively.

ZrO₂ increases the refractive index and improves the chemical durability of optical glass, and it is used in an amount of not more than 10 wt % of the composition. If the amount is more than 10 wt %, the meltability of the glass might be reduced excessively.

As mentioned above, according to the present invention, SiO₂, B₂O₃, BaO, Y₂O₃, Li₂O, and one or more from CaO, MgO, SrO, and ZnO are incorporated in optical glass as the essential components, and Na₂O, K₂O, Al₂O₃, and ZrO₂ can be optionally added. Sb₂O₃, As₂O₃, or other components also can be added as a defoamer. Refining agents, colorants, La₂O₃, Gd₂O₃, P₂O₅, and fluorides also can be added to an optical glass composition. This invention does not limit the use of those supplemental components insofar as these do not have some adverse effects on this invention.

Optical glass according to this invention can be manufactured by any suitable method or manner known in the art. Typically, raw materials such as oxide, carbonates, and nitrates are blended to make the composition as prescribed, molten at 1100° C. to 1400° C.; the composition is then agitated to make it uniform; the composition is then defoamed and then flown into a metallic die.

### EXAMPLE

Glass raw materials, oxides, carbonates, and nitrates, were blended into a composition shown in Table 1, then mixed well, then put in a platinum pot and kept in an electrically heated furnace and agitation for 1 to 2 hours at 1200° C. to 1400° C. The mixture, after being clarified, was cast into a preheated iron mold, and cooled to give optical glass. The refractive index (nd) at the helium d-line, the Abbe number (vd), and the transformation temperature are measured by methods well known to those in the art.

Composition of the glasses and measured results are shown in Table 1.

TABLE 1

| | Composition Number | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Glass | | | | | | | | | | | | | | |
| Composition | | | | | | | | | | | | | | |
| SiO₂ | 42.30 | 53.00 | 52.60 | 40.10 | 47.00 | 44.00 | 45.60 | 60.00 | 44.10 | 45.10 | 45.00 | 52.10 | 38.00 | 38.00 |
| B₂O₃ | 7.40 | 8.00 | 1.40 | 5.90 | 5.40 | 10.00 | 1.40 | 8.00 | 13.80 | 5.90 | 8.60 | 13.20 | 1.00 | 5.90 |
| BaO | 7.40 | 2.50 | 2.60 | 2.60 | 6.40 | 3.50 | 2.60 | 3.50 | 8.50 | 2.60 | 3.40 | 9.00 | 2.00 | 2.60 |
| Y₂O₃ | 1.30 | 2.00 | 3.10 | 1.60 | 8.00 | 5.00 | 3.20 | 3.30 | 2.00 | 3.20 | 1.50 | 1.10 | 1.00 | 1.60 |
| Li₂O | 9.70 | 5.50 | 4.70 | 6.80 | 8.80 | 5.50 | 6.80 | 5.50 | 3.20 | 6.80 | 7.50 | 6.20 | 3.00 | 3.00 |
| CaO | 4.30 | 5.50 | 13.10 | 29.10 | 10.00 | | 13.10 | 5.50 | 5.90 | 13.10 | 8.60 | 6.60 | 30.70 | 29.10 |
| MgO | | | 1.60 | 1.60 | | 15.50 | | | 2.00 | | 2.30 | 5.30 | | |
| SrO | 19.90 | 4.30 | 3.50 | | 4.30 | 4.30 | 3.50 | 2.00 | 5.70 | 3.50 | | | 7.50 | 5.50 |
| ZnO | 4.30 | 7.00 | 4.80 | 4.80 | 7.60 | 7.00 | 4.80 | 7.00 | 9.60 | 4.80 | 19.00 | | 14.00 | 11.70 |
| Na₂O | | 1.00 | 10.00 | 3.40 | | 1.00 | | 1.00 | 2.60 | 3.40 | 1.40 | | | |
| K₂O | | 1.00 | | | | 1.00 | 14.90 | 1.00 | 2.40 | | | | | |
| Al₂O₃ | 1.60 | 10.00 | 2.40 | 2.40 | 2.30 | 3.00 | 2.40 | 3.00 | | 2.40 | 1.50 | 2.00 | | 2.40 |
| ZrO₂ | 1.60 | | | 1.50 | | | 1.50 | | | 9.00 | | | | |
| Properties | | | | | | | | | | | | | | |
| nd | 1.61 | 1.56 | 1.58 | 1.62 | 1.61 | 1.59 | 1.59 | 1.56 | 1.59 | 1.62 | 1.61 | 1.58 | 1.66 | 1.64 |
| vd | 56 | 60 | 55 | 54 | 56 | 58 | 55 | 63 | 59 | 53 | 55 | 60 | 52 | 54 |
| Tg | 475 | 512 | 470 | 476 | 489 | 526 | 470 | 506 | 519 | 500 | 478 | 534 | 571 | 558 |

The glass compositions of the present invention were shown to make the transformation temperature low, as expected.

With respect to each of the compositions of Composition 6 and a glass composition that contains Nb₂O₅ and TiO₂ (corresponding to Example 9 in Japanese Unexamined Published Patent Application No. H06-107425), the wave length when the 10-mm internal transmittance was 80% was measured.

TABLE 2

| | | | Transmittance | | |
|---|---|---|---|---|---|
| | Glass composition | | (λ80) | nd | vd |
| Examples | SiO₂; | 44.0 wt % | 335 nm | 1.59 | 58 |
| | B₂O₃; | 10.0 wt % | | | |
| | BaO; | 3.5 wt % | | | |
| | Y₂O₃; | 5.0 wt % | | | |
| | Li₂O; | 5.5 wt % | | | |
| | MgO; | 15.5 wt % | | | |
| | SrO; | 4.3 wt % | | | |
| | ZnO; | 7.0 wt % | | | |
| | Na₂O; | 1.0 wt % | | | |
| | K₂O; | 1.0 wt % | | | |
| | Al₂O₃; | 3.0 wt % | | | |
| Comparative | SiO₂; | 50.0 wt % | 343 nm | 1.59 | 57 |
| Example | B₂O₃; | 7.5 wt % | | | |
| | BaO; | 10.0 wt % | | | |
| | Li₂O; | 10.0 wt % | | | |
| | SrO; | 17.5 wt % | | | |
| | Al₂O₃; | 3.0 wt % | | | |
| | Nb₂O₅; | 1.0 wt % | | | |
| | TiO₂; | 1.0 wt % | | | |

80% transmittance of the composition of this invention was positioned at a shorter wavelength compared to that of the comparative composition

This means that optical glass according to the present invention has lower absorbance in a short wavelength area in visible light, i.e., the glass is less stained.

Optical glass according to the present invention (i) does not contain Nb₂O₅ or TiO₂, (ii) has excellent transmittance, and (iii) can be moldable at a lower temperature.

It is industrially significant to be able to obtain optical glass without adding Nb₂O₅ or TiO₂, because Nb₂O₅ and TiO₂ can sometimes stain optical glass.

1-3. (Cancelled).

4. An optical glass, comprising:
(a) SiO₂ in an amount ranging from 38 wt % to 62 wt %;
(b) B₂O₃ in an amount ranging from 1 wt % to 15 wt %;
(c) BaO in an amount ranging from 2 wt % to 9 wt %;
(d) Y₂O₃ in an amount ranging from 1 wt % to 10 wt %;
(e) Li₂O in an amount ranging from 3 wt % to 12 wt %; and
(f) one or more oxides selected from the group consisting of (1) CaO in an amount less than 33 wt %, (2) MgO in an amount less than 16 wt %, (3) SrO in an amount less than 20 wt %, and (4) ZnO in an amount less than 20 wt %, wherein the total of said oxide(s) is in an amount of 10 wt % to 55 wt %.

5. The optical glass of claim 1, further comprising one or more compositions comprising one or more of the following: (g) Na₂O, (h) K₂O, (i) Al₂O₃, or (j) ZrO₂, wherein the sum of (g) Na₂O and (h) K₂O is an amount less than 17 wt %, (i) Al₂O₃ is an amount less than 10 wt % and (j) ZrO₂ is an amount less than 10 wt %.

6. The optical glass of claim 1, wherein the refractive index (nd) of said optical glass is 1.56-1.66, the Abbe number (vd) of said optical glass is 52-63, and the transformation temperature is 420° C.-580° C.

7. The optical glass of claim 1, wherein said SiO₂ is present in an amount of from 41 wt % to 62 wt %.

8. The optical glass of claim 1, wherein said B₂O₃ is present in an amount of from 3 wt % to 11 wt %.

9. The optical glass of claim 1, wherein said BaO is present in an amount of from 5 wt % to 9 wt %.

10. The optical glass of claim 1, wherein said Li₂O is present in an amount of from 4 wt % to 12 wt %.

11. The optical glass of claim 1, which does not contain Nb₂O₅ or TiO₂.

12. The optical glass of claim 1, further comprising a defoamer.

13. The optical glass of claim 12, wherein the defoamer is Sb₂O₃ or As₂O₃.

14. The optical glass of claim 1, further comprising refining agents, colorants, La₂O₃, Gd₂O₃, P₂O₅ or fluorides.

15. The optical glass of claim 1, having a transformation temperature of from 470° C.-571° C.

16. The optical glass of claim 1, having a λ 80 transmittance at 335 mm.
